(19) United States
(12) Patent Application Publication
(10) Pub. No.: US 2006/0070676 A1
(43) Pub. Date: Apr. 6, 2006

(54) Apparatus, system, and method of repairing conduit, and method of manufacturing a conduit repair apparatus

(76) Inventor: Richard D. Blackmore JR., Houston, TX (US)

Correspondence Address: PAULA D. MORRIS;MORRIS & AMATONG, P.C., 10260 WESTHEIMER, SUITE 360, HOUSTON, TX, 77042-3110, US

(21) Appl. No.: 11/217,108

(22) Filed: Aug. 31, 2005

Related U.S. Application Data
(60) Provisional application No. 60/605,957, filed on Aug. 31, 2004.

(51) Int. Cl. F16L 55/16

(52) U.S. Cl. 138/98; 138/97; 264/449; 264/269; 264/516; 156/294; 156/287; 156/94; 156/95

(57) ABSTRACT

A method of repairing a target section of conduit is provided. First, a repair apparatus is provided with a material structure that engages the conduit. The material structure is defined by a plurality of fibers such that the repair material is flexible and seamless. A curable resin is introduced into the repair material by either injection or infusion depending on the type of resin utilized. Next, the repair material is placed in the conduit in proximity to the engaged aged section or target section of the conduit. The resin in the material structure is then cured, while the repair apparatus is in place adjacent the target or damaged section.

The present application claims the benefit of the filing date of U.S. Provisional Application Ser. No. 60/605,957 filed on Aug. 31, 2004 (now pending) (which is hereby incorporated by reference for all purposes and made a part of the present disclosure).

### BACKGROUND OF THE INVENTION

The present invention relates generally to conduit repair and, more particularly, to a system, apparatus, and method for repairing conduits, and manufacturing a repair apparatus.

### SUMMARY OF THE INVENTION

In one aspect of the present invention, a method and a system are provided for repairing a target section or area (e.g., a section damaged by pitting or corrosion) of conduit. First, a repair material or apparatus is provided that preferably includes a plurality of fibers. More preferably, the fibers forms a substantially cylindrical material structure and/or imparts on the repair apparatus, flexibility and seamlessness. More preferably, the plurality of fibers are braided or knitted to form a substantially cylindrical material structure or fabric. Most preferably, the repair material has a matrix of intercrossing fibers that form a circumferentially expandable matrix structure. A curable resin is introduced into the repair material (e.g., by way of injection, infusion, or another suitable method). The repair material is placed in the conduit and in proximity of the target section, whereby the repair material flexibly conforms to an interior wall of the conduit. Thereafter, the resin in the material structure is cured (e.g., by ambient temperature, fluid applications, resistive heating, extralaminar heating, etc.).

According to another aspect of the invention, a repair material is provided with a material structure adapted to engage an interior surface of a non-linear conduit. The material structure includes a plurality of fibers such that the repair material is flexible and seamless. A curable resin is introduced into the repair material by either injection or infusion depending on the type of resin utilized. Next, the repair material is placed in the conduit in close proximity to a damaged portion of the conduit. Lastly, the resin is cured. Curing can be achieved in a number of ways, including but not limited to curing with hot water, steam, resistive heating, or infrared and ultraviolet radiation.

Preferably, the material structure is cylindrical to facilitate conformity with non-linear conduit. However, other configurations, such as an octagon or decagon, are feasible provided that the dimensions for the alternative shapes closely match the interior dimensions of the damaged conduit. The material structure is flexible and can be formed by braiding the fibers. Applicants have found that because braided repair material is formed with its reinforcing fibers positioned helically rather than perpendicularly to the longitudinal axis of the structure, these fibers have the ability to change their braid angle and conform simultaneously to both the inside radius and outside radius of a non-linear conduit. Consequently, repair materials fabricated by braiding offer an exceptional ability to conform to irregular conduit geometries.

The fibers can be electrically conductive fibers, for example carbon fibers. In order to cure the resin, an electric current can be caused to flow through the conductive fibers to resistively heat the repair material. Alternatively, the fibers can be a combination of electrically conductive fibers and non-conductive fibers, which include polyester, glass, aramid, and quartz fibers.

According to another aspect of the invention, the seamless material structure is formed by knitting the fibers. In knitting, the repair material is produced by interlooping continuous chains of fibers in a circular fashion. Because the fibers are looped in a circular fashion at every stitch, the finished tubular structure is flexible and able to conform to irregular conduit geometries. Various reinforcing materials can also be included in the knit construction to accommodate both performance and cost issues. In the interclooping of fibers in the knitting process, electrically conductive fibers may be used. This allows for resistive heating to be employed to cure the resin.

According to another aspect of the invention, the seamless material structure is formed from a combination of two or more material layers such as Stitch Bonding, filament winding or other non crimp methods. A first material layer is a cylindrical tube configured to fit within a second material layer that has a cylindrical tube configuration. The first material layer is nested within the second material layer and then stitch-bonded together with a stitching thread to form the material structure. Stitch-bonding is a method by which different materials can be consolidated into various forms including seamless, tubular products. The consolidation results from either continuous or intermittent stitching or sewing through the various layers of materials. In addition, electrically conductive fibers can be used such that resistive heating is feasible to cure the resin.

According to another aspect of the invention, the seamless material structure is formed from a combination of two or more material layers. A first material layer is a cylindrical tube configured to fit within a second material layer that has a cylindrical tube configuration. The first material layer is nested within the second material layer. In addition, electrically conductive fibers can be used such that resistive heating is feasible to cure the resin.

According to another aspect of the invention, an additive adapted to increase the resin viscosity is provided. The additive is mixed with the resin to form a resin-additive mixture whereby the resin viscosity is increased after a period of time has elapsed. The resin-additive adheres to the fibers in the first and second material layers. As a result, the resin-additive mixture stabilizes the fibers and the material layers. In addition, electrically conductive fibers can be used such that resistive heating is feasible to cure the resin.

According to another aspect of the invention, the fiber architecture is employed without conductive filament, however the same resin chemistry is retained. The electrically conductive fibers are embedded in a flexible, removable, reusable sleeve that is placed inside the resin soaked repair materially and subsequently resistively heated to thermal radiant the repair material creating a cured in place pipe within the vertical conduit. This aspect of the invention eliminates preliners, which electrically insulates the conductive fibers within the repair material. Cost is reduced since the expensive conductive filaments are now embedded in a reusable sleeve.

The invention has been described in connection with the preferred embodiments.

### BRIEF DESCRIPTION OF THE DRAWINGS

Various aspects of the invention will now be described by way of exemplary embodiments with reference to the accompanying simplified, diagrammatic, not-to-scale drawings.

FIG. 1 is a simplified partial cross section of a repair system according to the invention and applied to a target section of conduit, also according to the invention;

FIG. 2 is a simplified schematic of a system for repairing conduit material, according to the invention;

FIG. 3 is a simplified illustration of application of a heating element of the system in FIG. 2, according to the invention;

FIG. 4 is a simplified, diagram of an inflatable heating element, according to the invention;

FIG. 5 is a simplified illustration with cutouts, of one system for repairing a damaged section of conduit, according to the invention;

FIG. 6 is a simplified diagram of a repair material structure of braided fibers, according to the invention;

FIG. 6A is a simplified diagram of a repair material structure of knitted fibers, according to the invention;

FIG. 7 is a simplified flow chart and schematic of a manufacturing process for the heating element, according to the invention;

FIG. 8 is a simplified schematic of an alternative manufacturing process, according to the invention;

FIG. 9 is a simplified schematic of an alternative manufacturing process, according to the invention; and

FIG. 10 is a simplified schematic of a close loop automatic control system for an inflatable heating element of the repair system, according to the invention; and

FIG. 11 is a set of illustrations of a launch vessel for inserting a repair system into a conduit, according to the invention.

### DETAILED DESCRIPTION

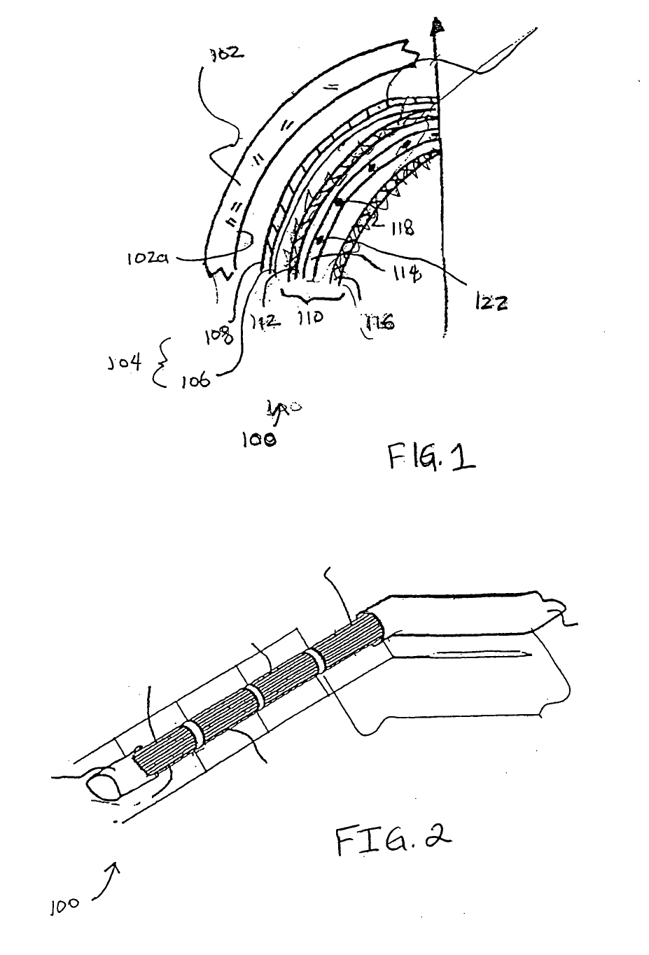

The present invention relates to a system, apparatus, and method for repairing a target section of conduit. The invention also relates to an assembly and method for manufacturing the repair apparatus and/or a component of the conduit repair system. FIGS. 1-11 illustrate and embody various aspects of the inventive system, apparatus, repair method, and manufacturing method. Some of the Figures illustrate and embody aspects of the invention in the context of repairing a damaged section of a cylindrical pipe. It is to be understood, however, that the present disclosure, particularly the Figures, is to be considered as an exemplification of the principles of the invention. This disclosure is not intended to limit the broad aspects of the invention to the illustrated embodiments.

Reference should also be made to the disclosure of United States Provisional Application Ser. No. 60,605,957 filed on Aug. 31, 20, which has been and is incorporated by reference for all purposes and made a part of the present disclosure. Particular reference is made to the set of claims filed with this provisional application. The claims provide a list of various aspects of the invention.

As used herein, the terms “repair” or “repairing” as it applies to a target section of conduit means to rehabilitate, reinforce, support, strengthen, or otherwise enhance or improve the mechanical and structural integrity of the target section. In this context, the target section typically applies to a damaged section of conduit, but may also be applied to a useable section of pipe that is in normal or less than normal condition.

U.S. Pat. No. 5,606,997, issued to Blackmore et al., (the '997 patent) relates to a method of rehabilitating conduit and materials used therefore. The present invention is related to the method and repair material disclosed in the '997 patent in that it is suitable for addressing needs and problems discussed in the specification. Furthermore, the present invention provides improvements or enhancements to the disclosed method and repair material. Moreover, the '997 patent provides additional background information that may be helpful in understanding the particular contribution of the invention to the prior art. Accordingly, the aforementioned '997 patent is hereby incorporated by reference for all purposes and made a part of the present disclosure.

The present inventive system, apparatus, and method are particularly suited for repairing a target damaged section of a non-linear conduit. In one aspect of the invention, the repair method entails providing a repair apparatus or repair material selected for placement in the area of or adjacent the damaged section. A repair apparatus or system according to one embodiment of the invention is placed adjacent the damaged section of conduit. The repair system includes a repair material or apparatus that is adapted to engage and preferably flexibly conform to the interior wall surface of the conduit. The repair material preferably includes a plurality of fibers that imparts on the repair material properties of flexibility and seamlessness. The inventive flexible and seamless repair material more easily conforms to the interior surfaces of the non-linear conduit. In place, the repair material eliminates or at least reduces binding or wrinkling, which may, otherwise, cause obstructions to material flow in the conduit.

Referring to the simplified illustration of FIG. 1, a repair apparatus or system 100 is shown being applied adjacent an internal surface or wall 102a of a cylindrical conduit 102. The internal wall 102a includes a target damaged section (not shown) of the conduit 102. The repair system 100 includes a repair material or repair apparatus 104 provided by a flexible reinforcing fabric 108 and a preferably non-conductive, elastomeric substrate 106. The flexible reinforcing fabric 108 is situated on the outside of and supported by the substrate 106. Before its placement adjacent the damaged section, the reinforcing fabric 108 includes or retains a curable resin therein. Upon completion of the installation, the outer surface of the reinforcing fabric 108 adheres to the internal wall 102a. Due to the structure of the fabric 108, particularly fibers or filaments making up the fabric, the repair material 104 is a flexible, circumferentially expandable continuous structure.

To engage the internal wall 102a, the repair material 104 is expanded using an inflation bag (e.g., blow molded polyethylene, nylon, polypropelene, or polyester film). The bag may employ fluid pressure, preferably pneumatic, to expand the repair material 104 into intimate contact with the internal wall 102a. The inflation bag is later removed (e.g., after the curing process).

In certain preferred embodiments, the material of the reinforcing fabric is fiber glass. As is discussed in further detail below, the fibers are preferably constructed in an advantageous intercrossing pattern to form a composite matrix structure. Further, the non-conductive substrate 106 may be aramid, quartz, polyester, or the like.

The repair system 104 of FIG. 1 further includes a curing or heating element 10 in the form of a heating jacket or heating sleeve 110. The heating sleeve 110 is inflatable or expandable to a generally cylindrical construction and is installed internally of the repair material 104. Preferably, the heating sleeve 110 includes an outer elastomeric skin 112, an inner elastomeric skin 116, and an electrically conductive, heatable heating layer 114. The heating layer 114 further includes conductive elements 120, such as electrically conductive fibers (i.e., resistive heat carbon composite). As will be further shown below, the heating sleeve 110 and its manufacture provide yet additional inventive aspects of the present invention.

By positioning the non-conductive substrate 106 between the heating sleeve 110 (i.e., heating conductive layer 114) and the interior wall 102a (and the conductive reinforcing fabric 108), an electrical circuit applied via electrical leads and connections (not shown) within the conductive layer 110 is isolated from the conductive surfaces of the conduit 102 (and, in some embodiments, of the reinforcing fabric 108). Accordingly, the repair system 100 of the invention may be used in the repair of electrically conductive pipes, e.g., cast iron, copper, etc. (as well as concrete pipe, PVC pipe, and the like). Upon conclusion of the curing process, the heat sleeve 110 is removed from the conduit 102 and from the repair material 104. The heating sleeve 110 may then be used and reused in other repair procedures.

Prior to placement in the conduit, a curable resin is introduced into the repair material, preferably by injection or infusion, depending on the type of resin utilized. In some embodiments, the resin is preferably thermoset or thermoplastic and more preferably, a polyester resin, a vinylester resin, a urethane-polyester resin, a urethane-vinylester resin, an epoxy resin, and/or a polyurethane resin. Next, the repair material is placed in the conduit in proximity of or adjacent a damaged section of the conduit, e.g., over a leakage source or corroded section. With the repair material in place, the resin in the structure is cured by one of several suitable curing processes. Curing may be achieved, for example, by employing hot water steam, intra and extralaminar resistive heating, or infrared and ultraviolet radiation.

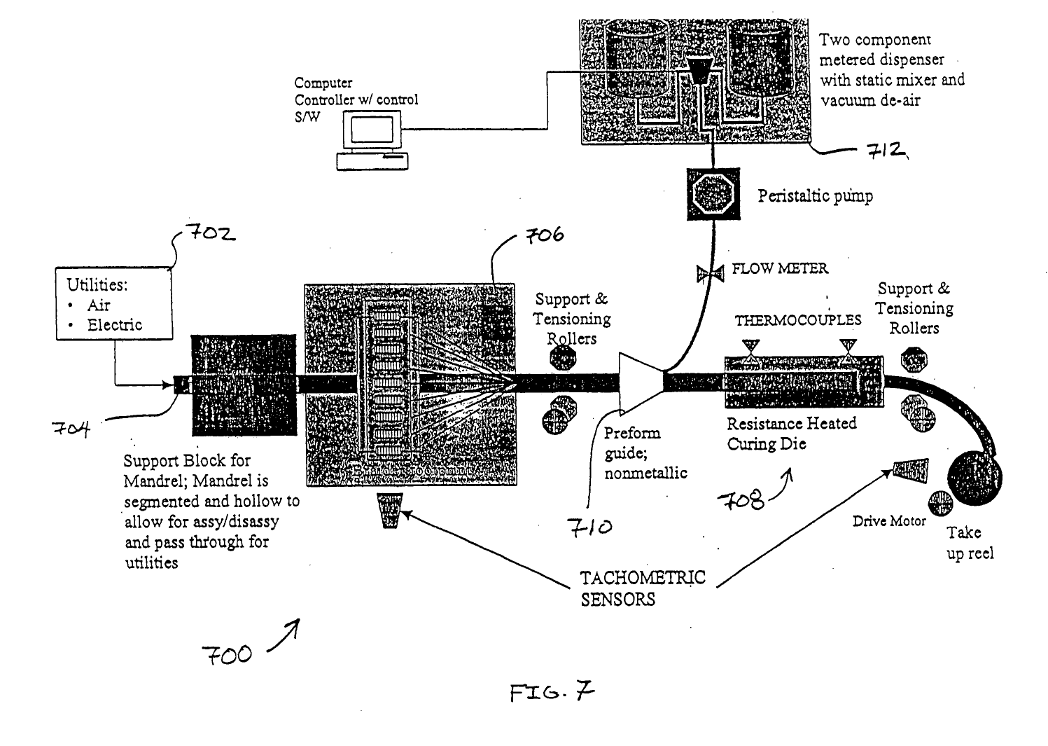

Preferably, the repair material structure is substantially cylindrical to facilitate conformity with the inside diameter of the conduit. However, the repair material structure is flexible and can be formed by mechanically or chemically consolidating the fibers. The fibers intercross to form a matrix of fibers. With this fiber matrix, the repair material is said to be “circumferentially expandable.” That is the structure can readily change its circumferential length and shape. FIGS. 6 and 6A provide detail illustrations of two suitable fiber matrix constructions. FIG. 6 illustrates a braided fiber construction. FIG. 6A illustrates an alternative construction provided by a knitting process. Both illustrate the type of intercrossing pattern that renders, at least partially flexibility (circumferential expandability to the repair material structure).

In an embodiment wherein the fibers are braided, most, if not all of the fibers are arranged in a helical pattern. However, triaxial braiding can be used to combine fibers at two different axial or helical angles with a non-helical, longitudinal fiber. Repair materials fabricated by a braiding processes offer exceptional ability to conform to irregular conduit geometries. Because a braided repair material is formed with its reinforcing fibers positioned helically rather than perpendicularly to the longitudinal axis of the material structure, these fibers have the ability to change their braid angle, and conform simultaneously to both the inside radius and outside radius of the non-linear conduit.

Depending on the desired mechanical properties, the density of the fiber braid can be varied to pack more fibers into the tubular arrangement and to increase the strength of the structure. Conversely, if the structural requirements are minimal, the braid density can be adjusted to where the material present in a volumetric area can be reduced. The angle at which the fibers intersect or intercross each other, otherwise known as the braid angle, can also be varied. When the braid angle is increased, the fibers are positioned closer to perpendicular or vertical and the hoop strength of the finished repair material increases. This is desirable for conduits that are required to support a great amount of weight or withstand high internal pressures. Various reinforcing materials can also be included in the braided construction to accommodate both performance and cost issues.

The fibers can be electrically conductive fibers, for example carbon fibers. To cure the resin, an electric current can be caused to flow through the conductive fibers, and, thereby, resistively heat the repair material or inflatable heating structure. Alternatively, the fibers can be a combination of electrically conductive fibers and non-conductive fibers, that include polyester, glass, aramid, quartz fibers or without conduit.

In another embodiment, the electrically conductive fibers have an exterior layer or coating of electrically non-conductive material. The non-conductive material is adapted to insulate the electrically conductive fibers, which are, then, braided. In another embodiment, the seamless material structure is formed by knitting the fibers. In knitting, the repair material is produced by interlooping continuous chains of fibers in a circular fashion. In a rochelle knit, it is possible to introduce the fibers in a basically longitudinal direction. Because the fibers are looped in a circular fashion at every stitch, the finished tubular structure is inherently flexible. For example, in one linear inch of fiber stitch, the actual fiber length may be as long as two inches. This allows continuity in the fibers throughout the length as well as allowing the fiber loops to stretch or open up to variances in the conduit geometry. Various reinforcing materials may also be included in the knit construction to accommodate both performance and cost requirements. In addition, electrically conductive fibers may be used in an inflation device, in which case, resistive heating is employed to cure the resin in the repair material.

In another embodiment, the seamless material structure is formed from a combination of two or more material layers. A first material layer is a seamless, cylindrical tube configured to fit within a second material layer that has a seamless, cylindrical tube configuration. The material layers are formed from an arrangement of fibers, preferably either braided or knitted fibers. The first material layer is nested within the second material and then stitch-bonded together with a stitching thread to form the material structure. Preferably, the stitch thread is elastic to further ensure flexibility of the repair material.

Stitch-bonding is a non-crimp method by which different materials are consolidated into various forms including seamless, tubular products. The consolidation results from either continuous or intermittent stitching or sewing through the various layers of materials. Reinforcing fibers may be used and aligned in a helical arrangement to accommodate geometry changes much like a braided composite. Stitch bonding also allows the use of a wider variety of electrically conductive material formats. Additionally, stitchbonded carbon/glass hybrid tapes may be introduced into the composite at opposite helical angles and coated with an elastomer substance, thereby serving as an inflatable heating sleeve.

In another embodiment, the seamless material structure is formed from a combination of two or more material layers. A first material layer is a seamless, cylindrical tube configured to fit within a second material layer that has a third layer that can be used as the flexible, removable, reusable heating sleeve. The material layers are formed from an arrangement of fibers, preferably either braided or knitted or non-crimp methods such as filament winding and stitch bonding fibers. The first material layer is nested within the second material layer and then needle-punched with a needle board to form the material structure. The needle board has a plurality of needles such that the needles penetrate the first material layer. When needles are driven through the first material layer, varying amounts of fibers from the first material layer are pulled through the cross section of the adjacent second material layer.

In another embodiment, an additive is provided to increase the resin viscosity. The additive is mixed with the resin to form a resin-additive mixture, wherein the resin viscosity is increased after a period of time. The additive maybe formulated such that the resin viscosity does not immediately increase. This guards against either resin introduction or resin permeation of the repair material. The resin-additive adheres to the fibers in the first and second material layers. As a result, the resin-additive mixture stabilizes the fibers and the material layers. In addition, electrically conductive fibers maybe used so that resistive heating may be employed to cure the resin.

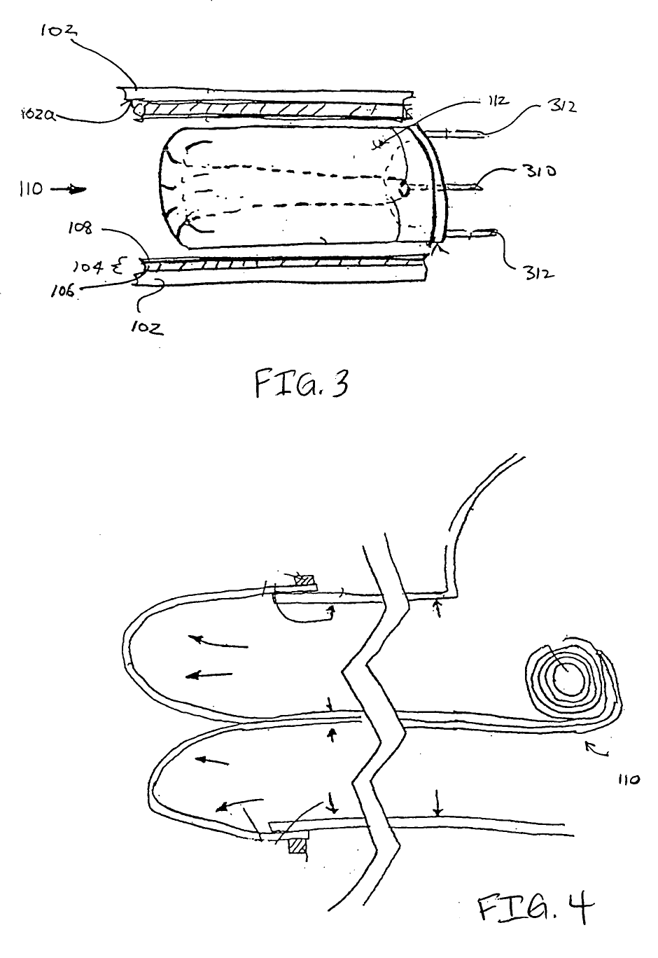

FIG. 2 is a simplified diagram of the system 100 of repairing a target section of a conduit 102, according to the invention. The heat sleeve 110 is shown on the outside, while repair material 104 is on the inside. In this way, the material 104 can be “soaked” with thermosetting resin and subsequently “inverted” into the conduit 102. The inversion process reverses the position of the two components, whereby the heat sleeve 110 is on the inside and the repair material 104 is on the outside and in intimate contact with internal wall 102a.

The perspective view of FIG. 2 shows various sections of the repair system. FIG. 2 specifically depicts, with cutout views, the heat sleeve according to the invention. As shown therein, electrical leads may be connected to the opposing ends of the heat sleeve. Alternatively, the second end connection may be tethered back inside the heat sleeve with a conductive wire to the first end so that the circuit is isolated to only one location.

FIG. 3 provides a simplified illustration of the heating sleeve 110 removed from the conduit. The heating sleeve 100 is shown in an inflated state just after conclusion of the curing process for the repair material 104. In this preferred embodiment, the heating sleeve 110 has a closed end onto which a tether 310 is operatively attached. The inflatable, heating sleeve 110 includes an outer elastomeric skin 112 that is disposed in the proximity of the repair material 104. In one respect, the heating sleeve 110 may be described as installed in an inverted condition. When an outer elastomeric skin, such as elastomeric skin 112, provides the only elastomeric layer of the heating sleeve 110, this outer elastomeric skin 112 is positioned radially outward of the conductive layer (which is typically a resistive heat carbon composite). As shown in FIG. 3, upon gradual installation into the conduit 102, the sleeve 110 is inverted such that the outer elastomeric layer 112 is provided radially outward of the other layers (as shown in FIG. 3). Upon conclusion of the curing process, the heating sleeve 110 is retracted by way of the tether 310. The inflatable heating sleeve 110 may be gradually pulled from the target section with the closed end section retracted first. Accordingly, the retraction process again inverts the inflatable heating sleeve 100. As a result, the heating sleeve 100 is in the initial uninverted state upon removal from the conduit 102.

Inflation of the heating sleeve 110 may be accomplished by a variety of suitable means. Furthermore, various fluids may be used for inflating the heat sleeve 110. In further embodiments, a hot fluid, such as water, may be used to inflate an alternative heating sleeve, such that the hot water provides the curing or heating source. Furthermore, the heating sleeve is preferably open on each side, such that fluid flow through the heating sleeve is possible.

In preferred embodiments, the outter and/or inner elatomeric layer may be constructed of materials such as RTV silicone, or a fluorosilicone, such as Viton. The conductive layer is preferably constructed of a carbon or graphite fibers, that are consolidated via crimped and non-crimped mechanical consolidation methods.

FIG. 4 is a simplified illustration of a coiled inflatable heating sleeve 110 suitable for use in installation of the inventive repair apparatus. It should be noted that the repair system according to the invention is preferably described as including the repair apparatus or repair material 104, as well as the heating sleeve 110, or another suitable heating or curing apparatus. It should be further noted that, as will become apparent below, the heating sleeve 110, and its employment in a conduit repair method embodies yet another aspect of the present invention.

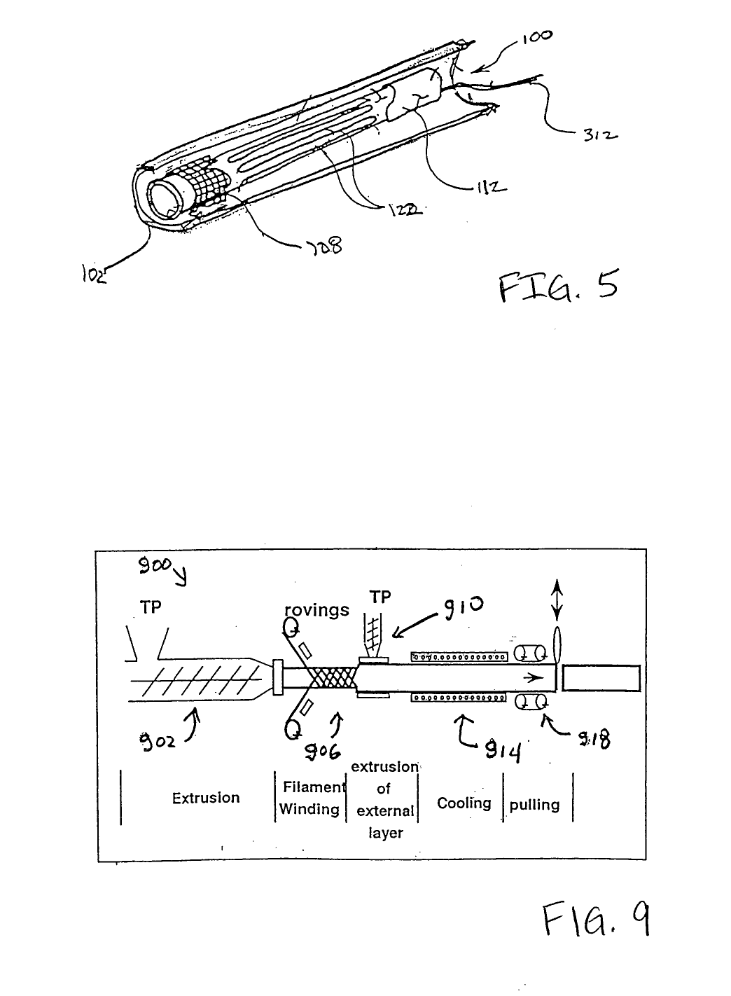

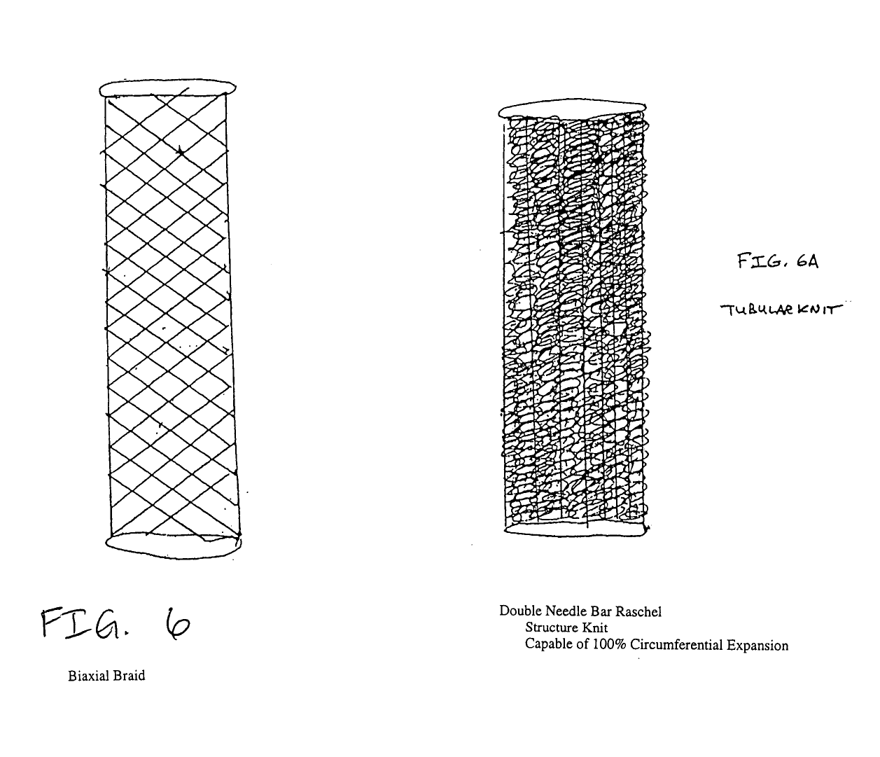

FIG. 5 is a simplified diagram, in perspective view and with cutouts, of the repair system 100 according to the invention. In this Figure, like reference numerals are used to refer to like elements, in respect to FIG. 1. The repair system 100 is shown having the reinforcing fabric layer 108 as a cutout on one end of the conduit 102 and the other end showing the outer elastomeric skin 112 of the heating sleeve 110. The conductive or heating layer 114 is shown situated in the middle section of the Figure. As shown in FIG. 5 the conductive layer 114 preferably includes carbon fiber construction 122 which, upon resistive heating, provides the heating source for curing the resin in the repair material 108. FIG. 5 also depicts electrical leads 312 provided on one end of the heating sleeve 110.

In another preferred embodiment, the inflatable heating sleeve is inverted or winched inside the flexible, resin soaked, repair material—such as the braids, knits or + or −45′ stitch bonded fabric Filament Winding, or the non crimp chemical consolidation by TechFab made from polyester, glass, aramid filaments. The inflatable heating sleeve may be manufactured on a braider, stitchbound, filament winder, or TechFab machine with a loose array of conductive fibers such as carbon.

FIG. 11 depicts a launch vessel system used to install a repair system (repair material and heating sleeve) inside a conduit and adjacent a remotely located damaged section of the conduit. The launch vessel system preferably employs pressurized air to position an attached inverted sleeve and repair material in the target section of conduit. Electrical conduits are maintained at the point/location where the sleeve is attached to the feed pipe.

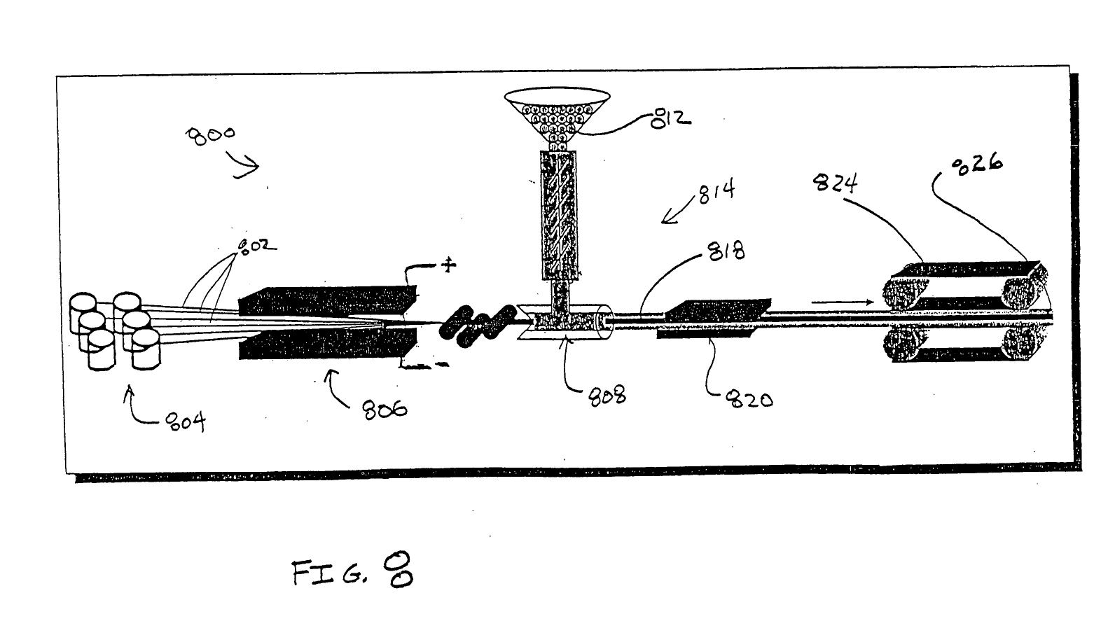

FIG. 7 is a simplified schematic of a manufacturing process and assembly for constructing one embodiment of an inflatable, reusable heating sleeve according to the invention. A manufacturing assembly 700 and process are illustrated schematically in FIG. 7. The assembly includes utility connections and resources 720, such as air, electric, and other common utilities. The principal components of the assembly 700 includes a rotatable, metallic mandrel 702, a braider unit module 706, and a resistive heated curing die 708. The assembly further includes a preformed guide 710 into which elastomeric material from an elastomer dispenser module 712 is fed.

Referring to FIG. 7, and from left to right, the process and assembly 700 includes a support block 704 for the mandrel 702. The mandrel 702 is preferably segmented and hollowed to allow for ready assembly and disassembly. Furthermore, the hollowed bore provides a conduit for utilities. In one aspect of the inventive assembly, the mandrel 702 is preferably electrically conductive and utilized as a part of electrical circuits.

The braider module 706 includes a braider unit 706a that is generally known and readily commercially available in the art. The braider 706a is positioned to feed conductive fiber or other heating element onto the mandrel 704. In alternative embodiments, the braider 706a may be replaced with a knitter, stitch-bonder, filament winder, or non-crimp chemical bonder. These machines mechanically consolidate fibers or filaments into conductive tubular fabrics of various circumferences. As shown in FIG. 7, the preferred fibers are wound about the mandrel and passes therefrom with assistance from support and tensioning rollers.

Downstream of the support and tensioning rollers, the preformed guide 710 (which is preferably non-metallic) is disposed about the mandrel 702. Tachometric devices 730 are used to control the output of the braider 706a. The preformed guide 710 applies viscous, liquid state elastomer onto the outer surface of the consolidated fabric fibers (which is wound about the mandrel 702). The preformed guide 710 is preferably an extrusion unit that applies the desired elastomer into and about the tube of braided fibers. The thickness of the application is regulated by the gap settings in the die head. This gap setting is provided by the narrowest portion of the cone shaped preformed extrusion unit.

Another module of the assembly 700 is a static-mixter pump system. This system 706 controls the ratio of the two part elastomeric system. The ratio controls the “thermoset” exothermic reaction that occurs later in the resistance heating curing die unit 708. The source of the elastomeric material is the dispenser 712. In the preferred embodiment, the dispenser is a two-component metered dispenser utilizing a static mixer and a vacuum de-air device. More preferably, the dispenser is controlled by a peristaltic pump and a computer controller.

The principal function of the resistance heating curing die module 708 is to further cure the elastomer that has been applied to the fabric. The preferred flourosilicate coating that is applied to the tubular fabric is uncured, but is cured in this module so as to consolidate the fabric and coating into a tubular shape. This curing process is effected by applying an electrical current through a circuit that includes the conductive mandrel. Internal connections inside the mandrel are activated to generate this “heating zone”.

FIG. 8 depicts in schematic form, yet another method and assembly 800 for manufacturing a heating sleeve according to the invention. In this alternative embodiment, a pulextrusion method is employed to manufacture the heating sleeve. The process is initiated with the delivery of conductive fibers 802 from a plurality of spools 804. The fibers 804 are passed in between an electrical heating device 806 and then guided into an impregnation pin device 808. The mixer receives elastomer pellets and melts the pellets 812, before application on the fibers 802. This stage of the process may be referred to as a co-extrusion stage 814. After the co-extrusion stage 814, the composite 818 of elastomer and fibers is passed through a conformation module 820. A pulling device 824 positioned downstream of the conformation module extrudes the finished heating sleeve composite in a continuous well 826.

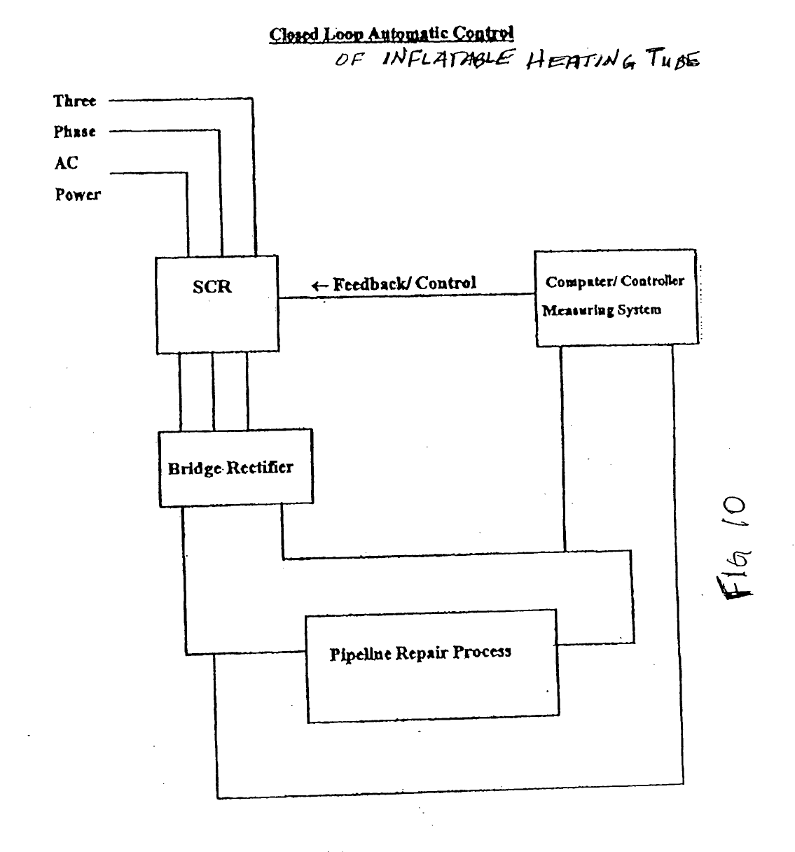

FIG. 9 depicts yet another variation of the assembly and method of manufacturing the heat sleeve, according to the invention. The assembly provides components different from the previously described assemblies. The process includes an extrusion process 902 in which a first polymer layer (inner material layer) is applied to a mandrel or equivalent. Thereafter, a filament winding unit or equivalent is used to apply the intercrossing pattern of fibers upon the elastomeric layer on the mandrel. This stage may be referred to as the filament winding or fabric application stage 906. The composite of fabric and inner elastomeric layer is then passed through a second extrusion stage 910. In this second extrusion stage, the additional elastomeric layer is applied to the outside of the composite. Thereafter, the three part composite is passed through a cooling module 914. As shown in FIG. 9, a pulling device 918 is used to draw a web of the finished heating sleeve composite.

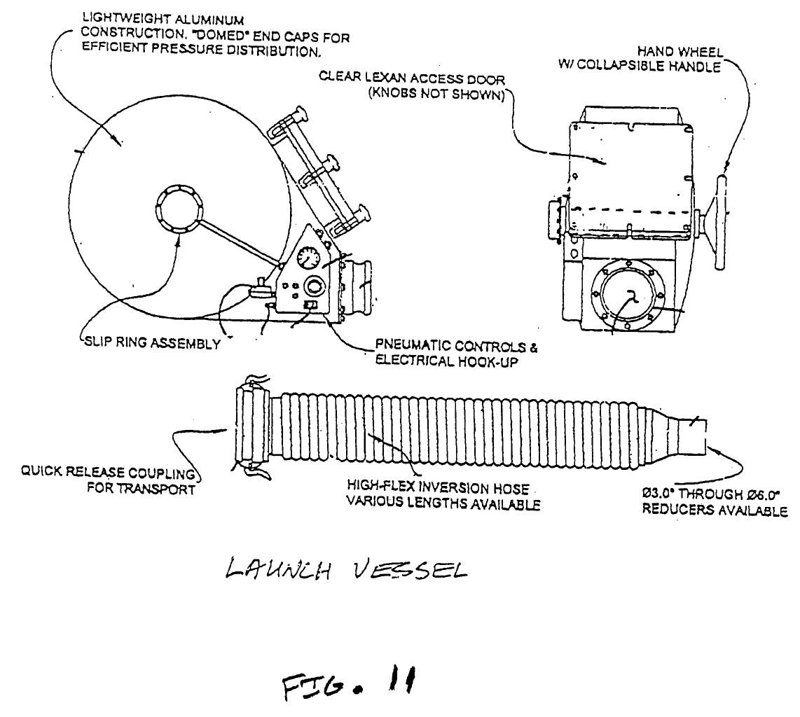

FIG. 10 is a simplified schematic of a suitable close loop automatic control system for use with the inflatable, heating element. The computer is configured to control the power and regulate the temperature requirements necessary of the heating sleeve. Preferred heat/power ranges are programmed into the computer and so that cure is accomplished without excess energy consumption or time loss. Additionally, the amount of elastomeric material applied is regulated to maintain constant thickness of the sleeve. This feature is also programmable in that the gap can be adjusted to meet special circumstances.

It should be noted that certain components as depicted in FIGS. 7-10, may be used in the manufacture of a repair material, according to the invention. Specifically, the mandrel, extruder, the resistive curing die module and other accessories may be used in a repair material manufacturing assembly. In certain embodiments, the same assembly may be used to produce a web of the repair material, as well as a web of the heating sleeve (although, not simultaneously). When the assembly is used for both purposes, the fiber content and extrusion content will, of course, be changed depending on the production requirements.

The foregoing description of the present invention has been presented for purposes of illustration and description. It shall be noted that the description is not intended to limit the invention to the systems, apparatus, methods, and manufacturing assemblies and methods disclosed herein. For example, the present invention should not be limited to the exact steps of the repair method and the manufacturing methods discussed above. Also, the invention should not be limited to the various configurations, assemblies, and/or structure of the repair apparatus as described above. Various aspects of the invention, as described above, may be applicable to other types of repair methods and systems. Furthermore, the repair apparatus and systems discussed above may be employed in structures and in processes that deviate from those discussed herein. Furthermore, certain steps of the methods described above may be eliminated, added onto, or modified for certain applications. Such variations of the invention will become apparent to one skilled in the relevant mechanical art provided with the present disclosure. Consequently, variations and modifications commensurate with the above teachings, and the skill and knowledge of the relevant art, are within the scope of the present invention.

The embodiments described and illustrated herein are further intended to explain the best modes for practicing the invention as presently known, and to enable others skilled in the art to utilize the invention in other embodiments and with various modifications as required by the particular applications or uses of the present invention.

1. A method of repairing a target section of conduit, said method comprising the steps of:
providing a repair material;
introducing a curable resin into the repair material;
placing the repair material in the conduit and in proximity to the target section; and
curing the resin in the repair material.

2. The method of claim 1, wherein said placing step includes placing the repair material, whereby the repair material flexibly conforms to an interior wall of the of the conduit.

3. The method of claim 1, wherein said step of providing a repair material, includes providing a repair material having a plurality of fibers forming a substantially cylindrical material structure.

4. The method of claim 3, wherein said providing step includes providing a repair material having electrically conductive fibers; and
wherein the curing step includes causing an electric current to flow through the conductive fibers to resistively heat the repair material, thereby curing the resin.

5. The method of claim 1, wherein said step of providing a repair material includes providing repair material having a matrix of intercrossing fibers forming a circumferentially expandable matrix structure.

6. The method of claim 1, wherein said step of providing a repair material includes providing a repair material having a plurality of interwoven fibers forming a matrix structure, said matrix structure having a flexible property that allows said repair material to circumferentially expand.

7. The method of claim 7, wherein said placing step includes circumferentially expanding the repair material to flexibly conform to the interior wall.

8. The method of claim 1, wherein said step of providing a repair material includes providing a material structure having fibers that are electrically conductive, said method further compromising the step of causing an electric current to flow through the conductive fibers to heat the repair material and cure the resin.

9. The method of claim 7, wherein said placing step includes providing a repair material having a material structure adapted to engage an interior surface on a conduit, the material structure being formed from a combination of a first material layer and a second material layer, the material layers defined by a plurality of fibers such that the repair material is flexible and seamless, wherein said curing step includes extralaminarly curing the resin in the repair material.

10. The method of claim 9, further comprising the step of causing an electric current to flow through the conductive fibers to resistively heat the repair material to cure the resin intralaminarly.

11. The method of claim 1, further comprising the steps of:
providing said repair material that has a material structure adapted to engage an interior surface of a non-linear conduit, the material structure being formed from a combination of a first material layer and a second material layer, the material layers defined by a plurality of fibers such that the repair material is flexible and seamless;
providing a resin, the resin having a resin viscosity;
providing an additive adapted to increase the resin viscosity of the resin;
mixing the additive with the resin to form an resin-additive mixture whereby the resin viscosity is increased;
introducing the resin-additive mixture to permeate the repair material; and
allowing the resin-additive mixture to adhere to the fibers thereby stabilizing the resin-additive mixture, the fibers, and material layers; and
wherein said repair material is placed in the conduit in close proximity to a damaged portion of the non-linear conduit; and
wherein said curing step includes intralaminarly or extralaminarly curing via a flexible, resistively heatable, removable sleeve.

12. A method of manufacturing a repair material for repairing a damaged section of conduit, said method comprising:
providing a mandrel;
applying a plurality of fibers on the mandrel to form a matrix structure of fabric material; and
applying an elastomer material on the mandrel and fabric to form an elastomeric layer adjacent the fabric layer.

13. The method of claim 12, wherein said step of applying the fibers includes braiding the fibers about the mandrel.

14. The method of claim 12, further comprising extruding a tube of the repair material, wherein the repair is a composite including a matrix structure of intercrossing fibers and elastomeric substrate.

15. The method of claim 14, further comprising passing an uncured composite of the fibers and the elastomer through a heating module prior to said pulling step.

16. The method of claim 15, wherein said passing step includes causing electric circuit to generate heat within said heating module, whereby the mandrel provides a portion of electric circuit.

17. A system for repairing a damaged section of conduit, said system comprising:
a flexible repair material structure configured to flexibly conforming to interior wall of the conduit;
a curable resin introduced within the flexible repair material structure; and
an inflatable, heatable sleeve insertable in the conduit adjacent the flexible material structure, and operable to heat the flexible repair material structure so as to cure the resin therein.

18. The system of claim 17, wherein said flexible material structure includes a configuration selected from the group of configurations consisting of:
a plurality of crimped fibers;
a plurality of intercrossing fibers supported on a substrate;
a plurality of fibers that are intercrossed such that the flexible material structure is substantially circumferentially expandable; and
combinations thereof.

19. The system of claim 17, further comprising an inflatable sleeve insertable within the flexible material structure, the inflatable sleeve being inflatable to expand the flexible repair material structure.

20. The system of claim 17, wherein said flexible material structure includes a seamless outer surface.
